(19) United States
(12) Patent Application Publication
(10) Pub. No.: US 2001/0040786 A1
(43) Pub. Date: Nov. 15, 2001

(54) COMPUTER HAVING DESKTOP COMPUTER FLOPPY DISK DRIVES AND NOTEBOOK COMPUTER DISK DRIVES MOUNTED THEREIN

(76) Inventor: CALVIN CHANG, TAIPEI CITY (TW)

Correspondence Address: DOUGHERTY & TROXELL, 5205 LEESBURG PIKE, SUITE 1404, FALLS CHURCH, VA, 22041, US

(21) Appl. No.: 09/299,517

(22) Filed: Apr. 26, 1999

(30) Foreign Application Priority Data
Dec. 3, 1998 (TW) 87220166

(51) Int. Cl. G06F 1/16

(52) U.S. Cl. 361/685; 361/683

(57) ABSTRACT

A computer includes a computer casing, a desktop computer floppy disk drive, a notebook computer disk drive device, a bracket and an adapter. The computer casing has a motherboard mounted therein. The desktop computer floppy disk drive is connected electrically to the motherboard. The notebook computer disk drive device has a notebook computer floppy disk drive and a CD-ROM (compact disk read-only memory) drive for a notebook computer. The bracket is mounted on the computer casing and has a receiving chamber for receiving selectively one of the desktop computer floppy disk drive and the notebook computer disk drive device. The adapter interconnects electrically the notebook computer disk drive device and the motherboard.

### BACKGROUND OF THE INVENTION

1. Field of the Invention

This invention relates to a computer, more particularly to a computer having a drive assembly that permits more disk drives to be mounted in the computer as compared to the conventional disk drive assembly.

2. Description of the Related Art

Referring to FIG. 1, conventional disk drive assemblies 15 for a computer are mounted on a sidewall 13 of a computer casing 10. The computer casing 10 has a motherboard 11 with a plurality of single-board mainframes 12 mounted thereon and a plurality of mounting racks 14 mounted on the sidewall 13. Each of the conventional disk drive assemblies 15 is mounted in a respective one of the mounting racks 14. Each of the disk drive assemblies 15 includes a bracket 16 with a receiving chamber 17 for receiving a desktop computer floppy disk drive 18 that is connected electrically to the motherboard 11. In this way, the data in the floppy disk drives 18 can be transferred to and processed by the single-board mainframes 12 on the motherboard 11. However, since the space in the computer casing 10 for receiving the floppy disk drives 18 is limited, the amount of the data to be transferred and processed by the single-board mainframes 12 from the floppy disk drives 18 is limited.

### SUMMARY OF THE INVENTION

The object of the present invention is to provide a computer having a disk drive assembly that permits more disk drives to be mounted in a limited space in a computer casing as compared to the conventional disk drive assembly.

According to the present invention, a computer comprises a computer casing, a desktop computer floppy disk drive, a notebook computer disk drive device, a bracket and an adapter. The computer casing has a motherboard mounted therein. The desktop computer floppy disk drive is connected electrically to the motherboard. The notebook computer disk drive device has a notebook computer floppy disk drive and a CD-ROM (compact disk read-only memory) drive for a notebook computer. The bracket is mounted on the computer casing and has a receiving chamber for receiving selectively one of the desktop computer floppy disk drive and the notebook computer disk drive device. The adapter interconnects electrically the notebook computer disk drive device and the motherboard.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional disk drive assembly of a computer that is mounted in a computer casing;

FIG. 2 is a fragmentary perspective exploded view of a preferred embodiment of a disk drive assembly of a computer that is mounted in a computer casing according to the present invention;

FIG. 3 is a perspective exploded view of the preferred embodiment of the disk drive assembly according to the present invention;

FIG. 4 is a perspective view of the preferred embodiment of the disk drive assembly according to the present invention; and

FIG. 5 is a front view of the disk drive assembly having a desktop computer floppy disk drive mounted therein according to the present invention.

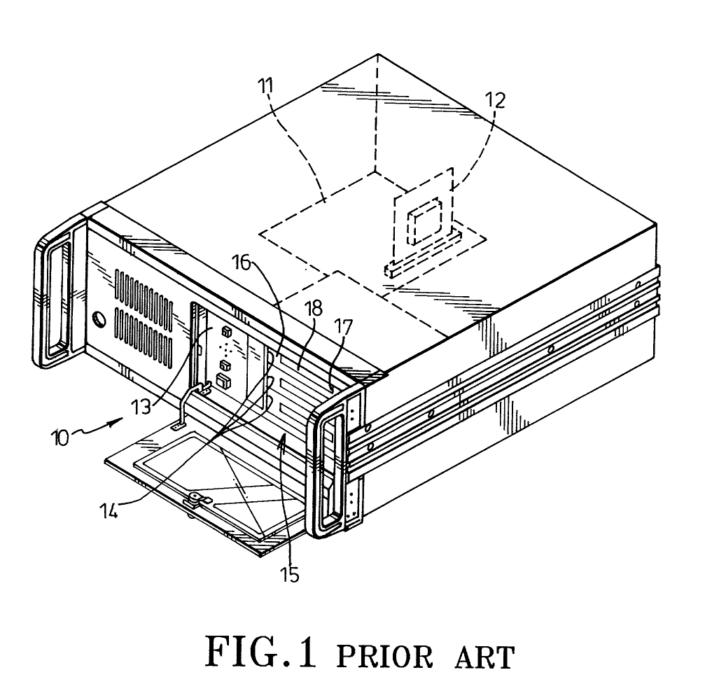

### DETAILED DESCRIPTION OF THE PREFERRED EMBODIMENT

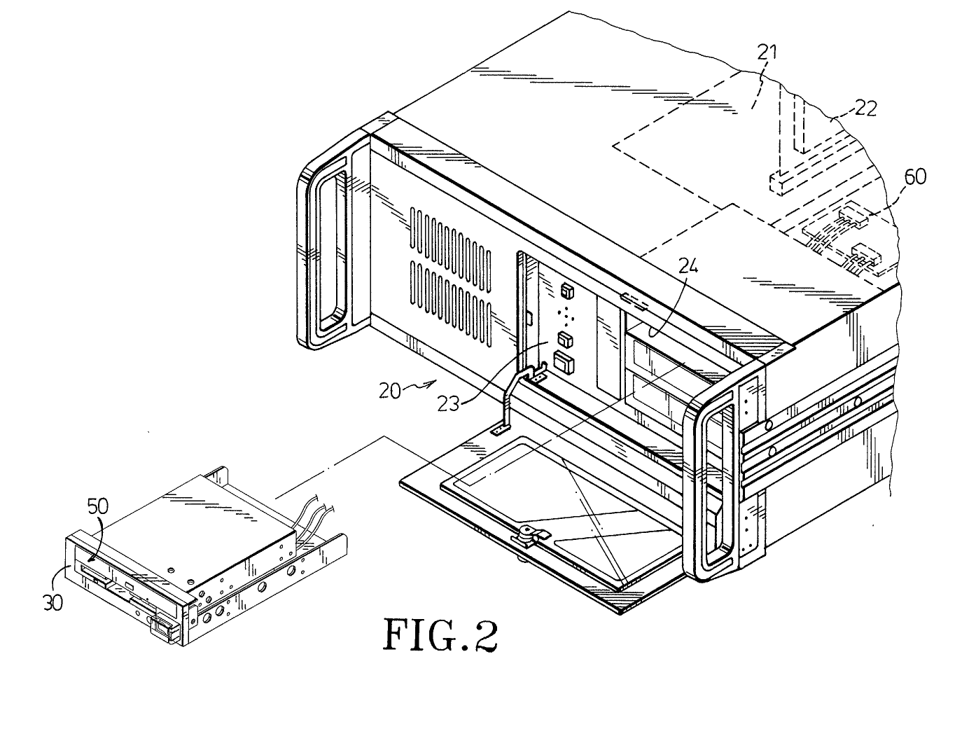

Referring to FIGS. 2 and 5, a preferred embodiment of a disk drive assembly of a computer according to the present invention is shown to comprise a bracket 30, a desktop computer floppy disk drive 40, a notebook computer disk drive device 50 and an adapter card 60. The disk drive assembly is mounted on a computer casing 20 that has a motherboard 21 with a plurality of single-board mainframes 22. A plurality of mounting racks 24 are mounted on a sidewall 23 in a conventional manner. The disk drive assembly is mounted in one of the mounting racks 24 of the computer casing 20.

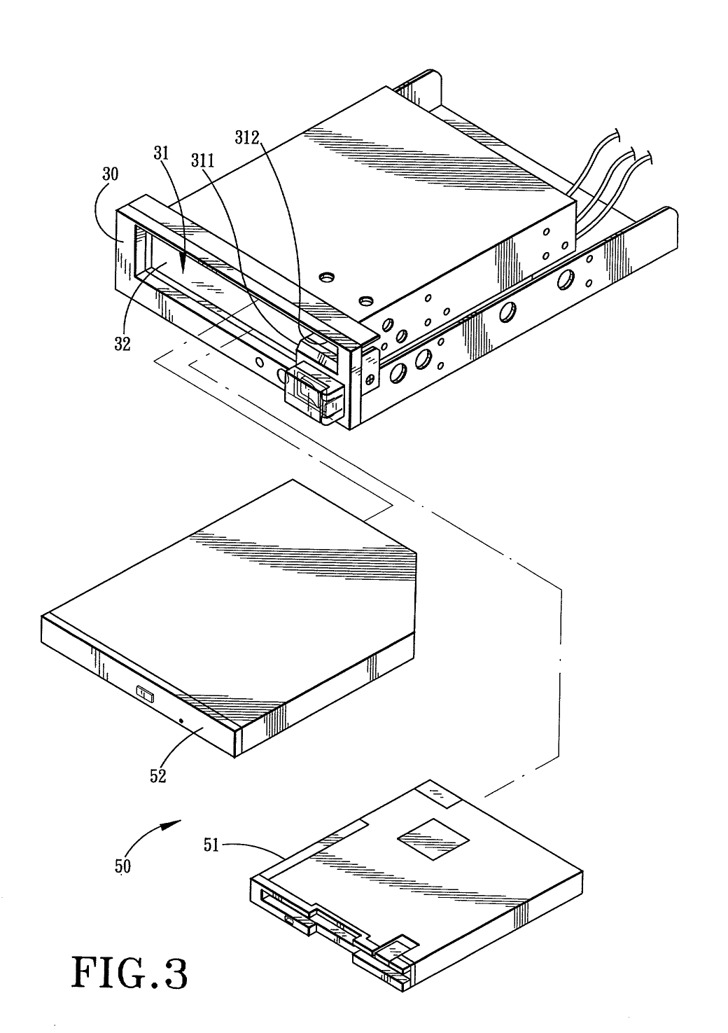

The bracket 30 is mounted on the computer casing 20. The bracket 30 has a receiving chamber 31 that consists of lower and upper receiving portions 311, 312 (see FIG. 3). A notebook computer hard disk drive 32 is mounted in a space below the receiving chamber 31.

The desktop computer floppy disk drive 40 is connected electrically to the motherboard 21.

Referring to FIG. 3, the notebook computer disk drive device 50 includes a notebook computer floppy disk drive 51 and a CD-ROM (compact disk read-only memory) drive for a notebook computer 52.

The adapter card 60 is connected to the motherboard 21 within the computer casing 10.

Referring to FIG. 5, the desktop computer floppy disk drive 40 is mounted in the receiving chamber 31 and is connected electrically to the motherboard 21 in order to transfer the data to be processed to the single-board mainframes 22.

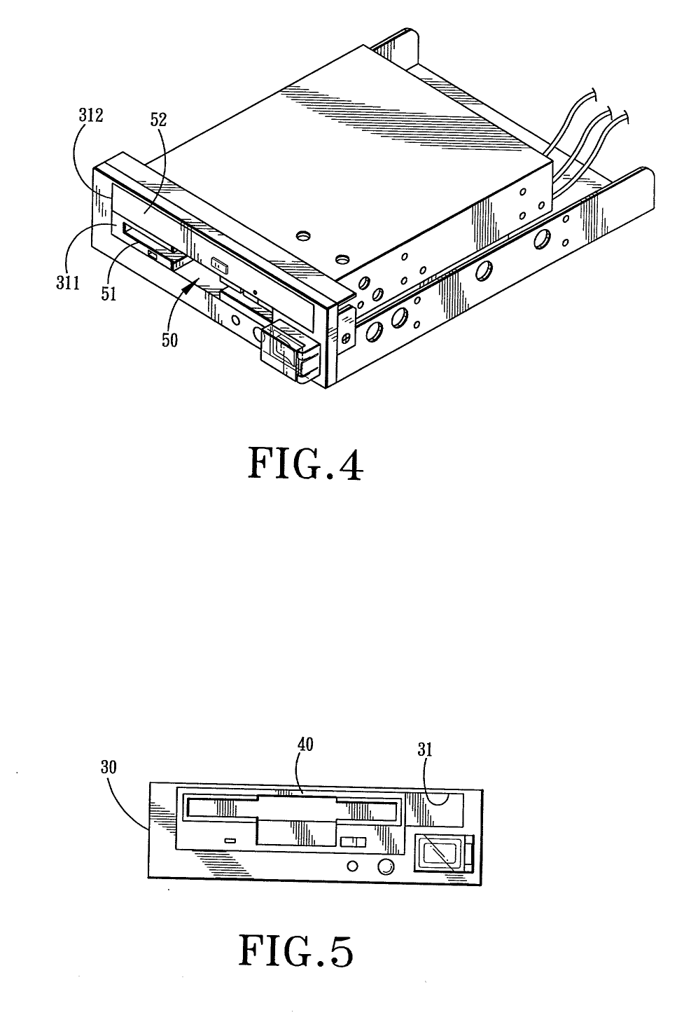

Alternatively, the notebook computer disk drive device 50 is mounted in the receiving chamber 31, as best illustrated in FIGS. 2, 3 and 4. The notebook computer floppy disk drive 51 is mounted in the lower receiving portion 311 and the CD-ROM drive 52 is mounted in the upper receiving portion 312. The notebook computer disk drive device 50 is connected electrically to the motherboard 21 via the adapter card 60. As such, the data signals of the notebook computer disk drive device 50 and the notebook computer hard disk drive 32 can be converted into the data signals that can be processed by the single-board mainframes 22 through the adapter card 60.

As mentioned above, the desktop computer floppy disk drive 40 and the notebook computer disk drive device 50 can be mounted selectively in the receiving chamber 31. When disposed in the receiving chamber 31, the total amount of the data that can provided by the notebook computer disk drive device 50 associated with the hard disk drive 32 is much greater than that provided by the desktop computer floppy disk drive 40. While only a single desktop computer floppy disk drive 18 can be mounted on a single aforementioned conventional disk drive assembly, different types of disk drives can be mounted selectively on the disk drive assembly of the present invention for added convenience during use. In addition, by virtue of the notebook computer disk drive device having a small size and high capacity, the amount of the data that can be processed by the single-board mainframes 22 is dramatically increased, thereby enhancing the performance of the single-board mainframes 22.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A computer comprising:
a computer casing having a motherboard mounted therein;
a desktop computer floppy disk drive connected electrically to said motherboard;
a notebook computer disk drive device having a notebook computer floppy disk drive and a CD-ROM (compact disk read-only memory) drive for a notebook computer;
a bracket mounted on said computer casing and having a receiving chamber for receiving selectively one of said desktop computer floppy disk drive and said notebook computer disk drive device; and
an adapter interconnecting electrically said notebook computer disk drive device and said motherboard.

2. The computer as claimed in claim 1, wherein said receiving chamber has lower and upper receiving portions in which said notebook computer floppy disk drive and said CD-ROM drive are mounted respectively.

3. The computer as claimed in claim 1, wherein said bracket has a notebook hard disk drive mounted below said receiving chamber.

4. The computer as claimed in claim 2, wherein said bracket has a notebook hard disk drive mounted below said receiving chamber.
